(19) United States
(12) Patent Application Publication
(10) Pub. No.: US 2008/0137668 A1
(43) Pub. Date: Jun. 12, 2008

(54) SOCIAL SEMANTIC NETWORKS FOR DISTRIBUTING CONTEXTUALIZED INFORMATION

(75) Inventors: Marko A. Rodriguez, Santa Fe, NM (US); Daniel Joshua Steinbock, Stanford, CA (US); Jennifer H. Watkins, Santa Fe, NM (US)

Correspondence Address: JOHN P. O'BANION;O'BANION & RITCHEY LLP, 400 CAPITOL MALL SUITE 1550, SACRAMENTO, CA, 95814, US

(73) Assignee: THE REGENTS OF THE UNIVERSITY OF CALIFORNIA, Oakland, CA (US)

(21) Appl. No.: 11/608,586

(22) Filed: Dec. 8, 2006

(51) Int. Cl. H04L 12/56

(52) U.S. Cl. 370/400

(57) ABSTRACT

A social semantic network provides for the efficient distribution of digital objects between users of that network. People in the network are connected by labeled edges that define relationships. Any person can create content in the form of particles, and by labeling that content, can determine how that content is distributed through the network. Labeled particles travel through each node in the network based on comparisons of the particle label with each edge label when exiting that node. Propagation can be controlled by the person at each node through which the particle travels or, alternatively, the system can be adapted to propagate particles one or two nodes at a time. Thus, a decentralized push-based system for distributing content is achieved without extensive regulation of that which is “appropriate” for consumers.

### STATEMENT REGARDING FEDERALLY SPONSORED RESEARCH OR DEVELOPMENT

This invention was made with Government support under Contract No. W-7405-ENG-36, awarded by the Department of Energy. The Government has certain rights in this invention.

### CROSS-REFERENCE TO RELATED APPLICATIONS

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to the distribution of information, and more particularly to the use of social semantic networks in the propagation of digital objects using a peer-to-peer distribution model.

2. Description of Related Art

Information is generally available in three different forms: text, audio, and video. A distribution medium is the means by which information, in any form, is distributed. Examples of text-based distribution mediums are newspapers and the World Wide Web (WWW) (i.e., web pages). Audio information is distributed via the radio and the WWW (i.e., mp3 or other audio file formats). Finally, video (which assumes audio integration) is distributed by means of television broadcasts and the WWW (i.e. mpeg or other video file formats).

Notice that the WWW, by means of the Internet, is the only distribution medium that can propagate information in all three forms. Though television, in theory, can distribute text and pure audio, its use has been primarily that of a video-based medium.

There are two major arguments against the use of television and radio as the primary mechanisms for information distribution. First, television and radio are limited in the amount of information they can effectively distribute. With limited bandwidth, the Federal Communications Commission (FCC) must regulate which individuals are able to broadcast and on which frequencies. This centralized regulation leads to the second major concern with television and radio as the sole means of distribution. With only a select group of individuals able to distribute information, the type of information distributed is biased towards the beliefs and values of those select few. That is, the information that is considered to be important enough to distribute is determined by a select few.

These arguments are two of the main reasons why the WWW has received unprecedented popularity in the last decade. The WWW embraces decentralized, bottom-up information generation and distribution. The difference between television/radio/newspaper and the WWW is found in their respective distribution models.

The one-to-many distribution model states that there exists a single (or limited set) of information or content producers that distribute information to the population. For television and radio, this is the current state. A network representation of the one-to-many distribution model is presented in FIG. 1, where the directed edges 12 going from left to right indicate that the single node on the left 14 is generating and distributing all the content being received by the nodes on the right 16.

The WWW, with its open publication model due to unlimited bandwidth and negligible regulation, allows anyone to create and consume material. In this model, publishers (creators) and viewers (consumers) can be the same individual. This model is represented as a network in FIG. 2, in which every individual 18 can disseminate information to and receive information from any other individual 18 in the population via bidirectional edges 20.

One of the major limitations of the many-to-many model is also its greatest benefit. With the vast amount of information created, locating which information is most applicable to the individual becomes difficult. For this reason, search engines, such as Google, have been developed to indicate relevant sites to an individual searching for particular information. However, the search engine paradigm is limited in that an individual is required to know a priori the type of information in which he or she is interested. This form of media consumption is a pull-based model, in which information exists and individuals must locate for themselves their desired information for consumption.

In order to provide the consumer with potentially useful information, push-based models of information propagation have been created. For instance, web-services such as Amazon.com utilize recommender system technology to push potentially desired products to a consumer.

### BRIEF SUMMARY OF THE INVENTION

The media distribution system of the present invention utilizes a push-based information retrieval model. The proposed system allows the individual to subscribe to certain information/content creators. These subscriptions allow an individual to state sources from which information is desired. In a framework similar to that of recommender systems, the proposed system then ‘recommends’ or ‘pushes’ information/content to the end consumer. A social semantic network of subscriptions serves as the infrastructure, which contextualizes the topics that would be most relevant to the individual. This distribution model can be called a peer-to-peer distribution model, in which digital objects flow in a selective manner between individuals.

Thus, the system of the instant invention is embodied in a combination of the following three constructs: (a) a social semantic network, in which at least two people are connected by a plurality of labeled edges; (b) labeled particles, in which digital objects or data, such as information or a pointer to information, is embedded; and (c) a propagation algorithm, in which particles are pushed through the network when a label on the particles match a label on the network edge.

An aspect of the invention is a distribution system, comprising: a network comprising a plurality of people connected by a plurality of labeled edges; labeled particles comprising embedded content; and a propagation algorithm; wherein each person in the network occupies a separate node in the network; and wherein the algorithm pushes each particle to nodes in the network when a label on that particle matches a label on any edge.

In other embodiments of this aspect, the edges comprise multiple labels; the particles comprise multiple labels; a person can add or modify labels on labeled particles before the particles are pushed past that person's node; a person can add or modify labels on labeled edges connected to that person; the labels comprise an identifier regarding the content of the embedded content; the labels comprise an identifier regarding people in the social network; or each label comprises a digital object.

In other embodiments, the propagation algorithm comprises pushing particles only one node at a time or the propagation algorithm comprises pushing particles more than one node at a time.

Another embodiment of this aspect further comprises an information space at each node; wherein each person is associated with a separate information space. In another embodiment, each information space at each node comprises: a plurality of particles received at that node; wherein particles are not propagated past that node until the person associated with that information space processes the particles.

In still other embodiments, propagation through each node is approved by the person at that node or multiple copies of particles propagate through the network if a node comprises multiple edges having labels matching labels on the particles.

Another aspect of the invention is a distribution system, comprising: a social semantic network comprising a plurality of labeled edges; a plurality of particles; and a propagation algorithm; wherein each particle comprises at least one label; and wherein each particle is propagated along edges through the network based on comparing the particle label to the labeled edges.

In an embodiment of this aspect, the labels are digital objects. In another embodiment, each edge comprises a plurality of labels. In another embodiment, multiple copies of a particle propagate through the network if multiple edges have labels matching labels on the particles.

In another embodiment of this aspect, particles are generated within the social semantic network.

A still further aspect of the invention is an apparatus for distributing content, comprising: a computer; and programming on the computer for performing the steps of: creating edges between people in a social network; accepting labels associated with the edges; propagating particles along the edges in the network; accepting labels associated with the particles; and determining if at least one of the labels on the particles match at least one of the labels on the edges as a condition for propagation of each the particle to a next person in the social network.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 shows a one-to-many distribution model.

FIG. 2 shows a many-to-many distribution model.

FIG. 3 shows a peer-to-peer distribution model.

FIG. 4 is a depiction of individual A as both a content creator and a content consumer.

FIG. 5 shows A's tagged creator and consumer relationships according to the instant invention.

FIG. 6 shows the propagation of a “science” particle through the social semantic network according to the instant invention.

FIG. 7 shows the propagation of multi-tagged particles through the social semantic network.

FIG. 8 is a depiction of A's personal, categorized information space according to the instant invention.

### DETAILED DESCRIPTION OF THE INVENTION

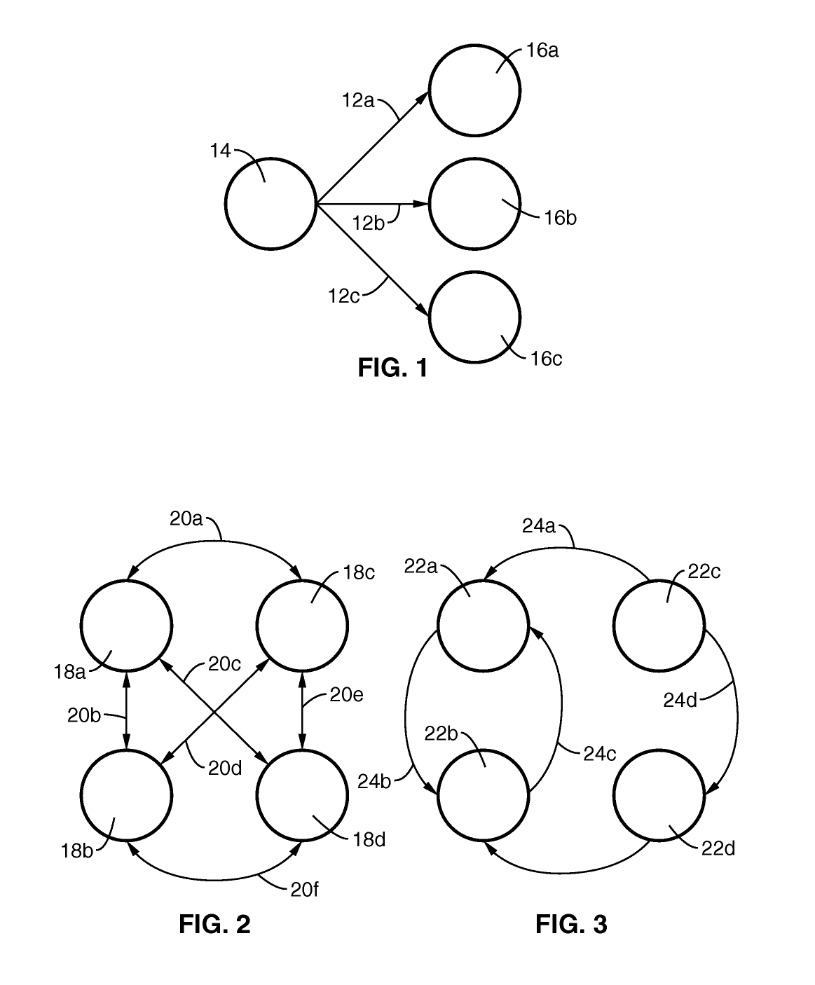

Referring more specifically to the drawings, for illustrative purposes the present invention is embodied in the system and method generally shown in FIG. 1 through FIG. 8. It will be appreciated that the system may vary as to configuration and as to details of the parts, and that the method may vary as to the specific steps and sequence, without departing from the basic concepts as disclosed herein.

1. Foundation

The purpose of a content distribution system is to ensure that the information generated and the information distributed is free from the control of a top-down authority. Popular distribution mediums such as radio and television are structured in a top-down fashion due to their inherent limitations. Because of finite airtime and a small number of broadcast frequencies, the information generated and disseminated by television and radio is regulated by relatively few individuals.

With the advent of the Internet came a decentralized form of information distribution. Any individual can produce and publish information on the World Wide Web (WWW) for any other individual to consume. Without restrictions on airtime or FCC regulations, Internet-based content propagation has two major advantages. First, the WWW is a bottom-up means by which individuals can create and distribute information that is easily alterable and accessible at any time. Second, it is an unregulated medium that allows uncensored publishing. The range of potentially relevant topics to an individual is immense. Individuals can locate those news media forums that best suit their tastes. The WWW, as a content distribution system, abstains from regulating content and thus supports all personal values and beliefs, in which information or content is generated in a bottom-up manner to support the uncensored distribution of information within a society.

Like the WWW, the content distribution system of the instant invention allows any individual to be a creator and consumer of content. Also, like the WWW, the proposed system allows for the distribution of content in multiple forms, such as text, video, audio, still pictures, etc. However, unlike the pull-based model of the WWW, where users must actively locate pertinent content or information, content is propagated through a collectively generated social network. Thus, the system of the instant invention is a push-based peer-to-peer (p2p) content distribution medium. The social network serves to propagate content from one individual to another using “particles”. Furthermore, the system capitalizes on common user-based classification or tagging methods. Individuals are able to tag both their neighbors and the traversing particles with self-generated keywords. These tags then provide a way to intelligently route information through the social network in order to ensure that the content received by an individual is relevant to his or her interests. The aggregation of particles on an individual's node in the social network forms the individual's personal information space, wherein propagated information is viewed and new information is encapsulated in a particle, tagged, and distributed. The proposed system is a bottom-up means for generating and distributing information devoid of any authoritative definition of what should be classified as important or worthy of distribution.

With this in mind, note that the present invention utilizes a social semantic network, characterized as follows. In the common sense, a network is composed of one or more binary relationships, in which a binary relationship (edge) connects two nodes. By contrast, a semantic network makes a tertiary relationship (a semantic edge) by connecting two nodes and a label. This label is commonly thought of as a character string, but in theory, this label can be any digital object. Finally, a social semantic network is a semantic network in which the nodes are specific references to humans. Thus, humans are related to one another by a labeled edge and that labeled edge serves as the categorized channel by which contextualized information is distributed amongst the humans in the social semantic network.

A peer-to-peer media distribution model (FIG. 3) is favored over other methods for many reasons. First and foremost, unlike the one-to-many distribution model, in the peer-to-peer model, information/content is no longer created by a single source (or a few sources), but instead can potentially be created by any individual 22 in the system. That is, each participant 22 can determine for themselves what content is considered relevant and propagate that content to others via edges 24. Important content may include scientific manuscripts, community updates, humorous image files, political propaganda, etc. What is deemed important information for one individual may not be deemed important for another. Also, any individual can publish any content that is relevant to his or her subjective understanding of importance. Other individuals choose to consume or not to consume another's published material. Therefore, the very concept of relevant or desirable content in this system is decentralized and distributed amongst the community. There is no administrative control over what is deemed ‘worthy of propagation’.

2. Proposed P2P Content Distribution

This section will discuss the underlying technology that allows for the propagation of self-generated information content within a peer-to-peer distribution medium.

2.1 Social Network Constructs

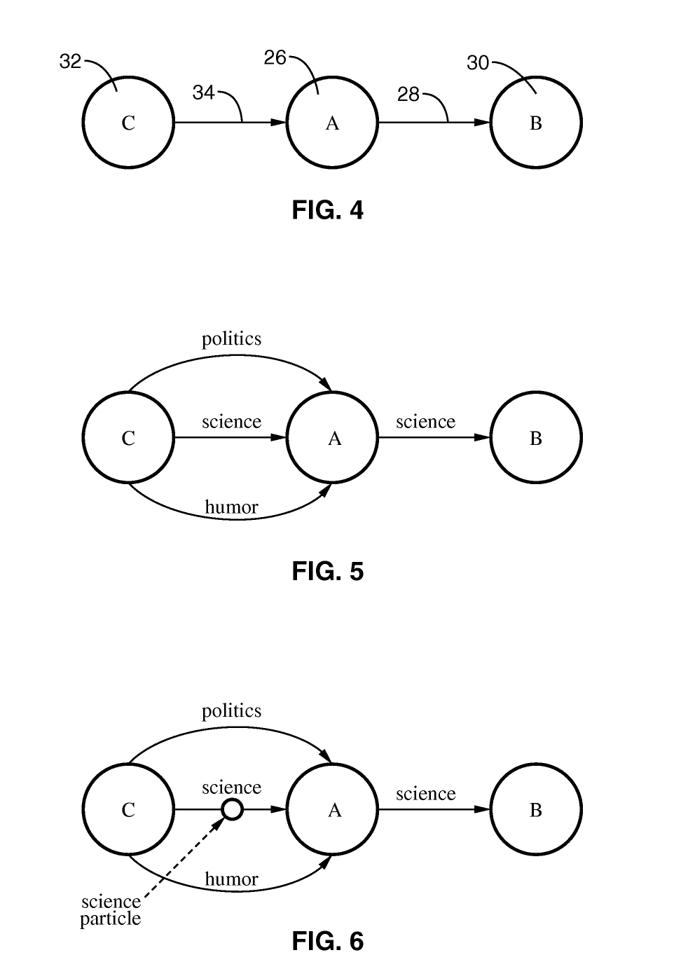

The communication channel for the content propagation is a social network. A social network is a network that connects human individuals. For example, individual A 26 can make a directed link 28 to individual B 30. That is, A can state a belief that B would be interested in his or her flavor of information. Furthermore, A can desire content generated from individual C 32. Therefore, A can ‘force’ C to create a directed link 34 from C to A. In this sense, A subscribes to information published by C. The individuals that provide outgoing edges are called creators. The individuals that receive incoming edges are called consumers. In FIG. 4, C is A's creator and B is A's consumer. Furthermore, A is considered B's creator, and C's consumer. The definition of creator and consumer is dependent upon one's location in the network.

Given that humans have multiple interests and therefore create and consume multiple types of information, it is important to label which type of information is desirable for consumption. Individual B may desire only to receive ‘science’ information from A while A may desire to receive ‘science’, ‘politics’, and ‘humor’ information from C. To represent this, the relationships made between individuals are labeled, or tagged, as presented in FIG. 5. This creates the social semantic network. The tags are used to categorize link types and are derived using bottom-up folksonomy technology. It is important to note that a label can be any digital object, and need not be a character string.

2.2 Defining a Particle

A particle is an item of information that is created by an individual for distribution along the individual's outgoing links. A particle can contain any digital object, or data in any convenient form, such as text, images, audio, video, software/executables, or simply a reference to a Uniform Resource Identifier (URI). Generally speaking, a particle has no limits on the type of data it may contain. A particle can be encoded in any available manner. Some encodings, for example, allow an individual to attach associated metadata to the particle. Attached information may be the particle's original creator, chain of distributors, date of creation, etc. Most importantly, the metadata allows for an individual to tag, or categorize, the particle. These tags determine over which edges the particle can propagate. As a side note, the system of the present invention can be configured with respect to applicable copyright infringement laws.

In FIG. 6, for example, a particle is created by C, and then tagged by C as ‘science’. Thereafter, the particle is propagated to A via the ‘science’ labeled edge. The network relationships existing between individuals A and C create a presumption that A is familiar with C's meaning of ‘science’ and finds such ‘science’ information from C to be interesting. Particles that are tagged as ‘science’ will then be able to propagate from A to B via the ‘science’ labeled edge.

The lifespan of a particle is determined by its popularity. Referring again to FIG. 6, imagine that C created a ‘science’ particle. Because A subscribes to C's created ‘science’ content, A would receive C's ‘science’ particle. If A does not like the particle, or does not deem it worthy of being propagated, then B will not receive C's ‘science’ particle. However, if A finds the content interesting and therefore worthy of propagation, then B would receive the particle. Each individual is a creator through reinterpretation of information/content whether that particle was originally created by that individual or received from another source. Therefore, each individual controls the information he or she propagates through personal rating and further tagging of each particle. Each individual, therefore, decides what content is appropriate and then propagates only that “appropriate” content to his or her own consumers. Ratings and tags provide a filter and routing mechanism for the particles in the network. The step-by-step regulation is a way to control spamming. On the other hand, it can be seen as decentralized censorship. For instance, A can refuse to propagate all ‘science’ content from C. To thwart censorship, the particle can either take another path in the network to arrive at B, or B can directly subscribe to C's ‘science’ stream and thus bypass A's distribution step.

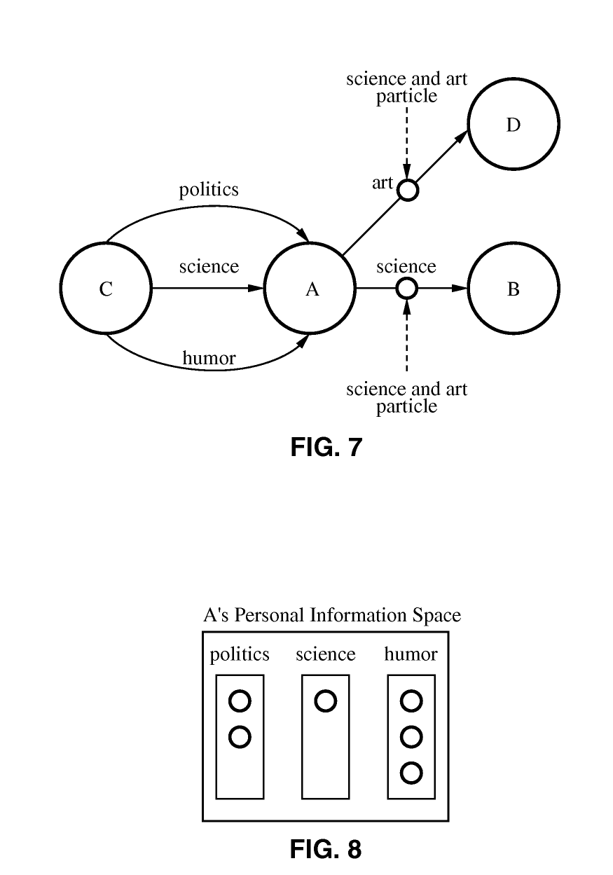

Furthermore, A may read the ‘science’ particle created by C and deem the particle more ‘art’ than ‘science’ and thus manipulate the tags associated with the particle. According to FIG. 7, if A removes the ‘science’ tag and then tags the particle ‘art’, then only D would receive the particle. On the other hand, if A simply amends the tag to add ‘art’, then both D and B would get C's particle, which is now tagged as both ‘art’ and ‘science’. This demonstrates how dynamic tagging facilitates subjective categorizations. Tagging can prove useful if A denoted all his or her consumer friends with a tag such as ‘myfriends’. In such cases, any particle that A believes all of his or her friends would enjoy can simply have the tag ‘myfriends’ added to the tag list. Note that the particle needs to copy, or clone, itself so that it may take all the appropriate edges allowed by multiple tags.

Finally, given that each step of propagation is controlled by each individual, information propagation can be delayed by those who do not process their incoming particles in a timely manner. To handle such situations, a particle creator may propagate a particle more than one step in the social network. That is, a creator may deem a particle so important that it propagates up to three steps from his or her node. For example, if C believed that his or her created ‘science’ particle was extremely important, then C can propagate the particle two steps. C would supply B with a ‘science’ particle even though A has not provided a seal of approval. It is important to limit the maximum number of steps that an individual can propagate a created particle in order to control spam behavior. The balance between what is considered censorship (or long delay times) and spam (or large distribution steps) is determined during system design and initial testing.

2.3 Defining a Personal Information Space

Every individual in the system has a personal information space. An individual's information space contains an aggregation of all the particles that have reached that individual's node. Therefore, an information space is personalized according to the subscriptions of the individual. Furthermore, an individual's subscription is defined recursively as all the subscriptions and ratings that preceded the individual from creator to end consumer. The method of how this information is ultimately delivered to the consumer is implementation-specific and can be one or more of many digital object consumption interfaces, including, for example, web portals, RSS feeds, local clients, and e-mail clients, among others.

An individual can ‘close’ particular particles and clear his or her information space of content or material, much like deleting an e-mail. The information space serves as the interface by which individuals rate particular particles. As discussed previously, positively rated particles continue to propagate while negatively rated particles are no longer propagated.

The information space interface can also serve as the means by which an individual creates novel particles. A section of the information space will provide an interface to upload files or input URI references, to initially tag the particle, and to set a desired number of steps to traverse (i.e. an integer). Submitting this information generates the particle and propagates it along the appropriate semantic social network edges.

3. Implementation

There are multiple ways to implement the system of the instant invention. One way is to make the system a client-based program similar to the popular instant messaging client software. An individual can add any number of consumers and creators and supply appropriate tags as desired. A central server can provide directory services for locating personal friends, highly rated information/content creators, etc. Furthermore, the client-based software provides an interface for the individual's personal information space.

Another implementation can be purely web-based where a user logs into a web-service via a web-browser. After login, the user is directed to his or her personal information space and creator/consumer list. Much like the client-based method, creators and consumers can be tagged and a directory service can be provided.

There are pluses and minuses to both implementation styles. In the client-based software model, the system is completely distributed. Unfortunately, for particles (content and information) to propagate, clients must be online to maintain the peer-to-peer infrastructure. Therefore, offline clients can effect overall particle distribution.

Conversely, the web-based model is not affected by non-active users. However, it is a centralized model in that all particles, personal information spaces, and semantic social network information are stored on the web-service server. This may allow for deviant administrators to tamper with information/content distribution. Furthermore, this system costs money to maintain because a central hosting service is required. The implementation style is determined during the design phase of the project.

4. Benefits and Conclusion

The benefits of this information/content distribution system are many. First, the proposed system allows people to determine what is important to them and to their consumers without any external, top-down control of what is deemed appropriate. Second, the system is media independent because any digital object can be propagated within the social network. Third, the system is scalable in that it can he implemented in a peer-to-peer fashion. The system improves with scale as more users create and classify the particles propagating through the network. Fourth, the system is sustainable at an extremely low cost. After initial development, the only cost is to maintain a web hosting contract if that becomes the implementation model. Finally, the concepts driving this system are simple to implement and therefore can be adopted by existing social software services.

Thus, the system of the present invention creates a distributed and dynamic information gathering and filtering service to better pair information with an interested audience. Such a system does not impede, but instead enables participants to intelligently navigate the ever-expanding world of available information/content.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A distribution system, comprising:
a network comprising a plurality of people connected by a plurality of labeled edges;
labeled particles comprising embedded content; and
a propagation algorithm;
wherein each person in said network occupies a separate node in the network; and
wherein said algorithm pushes each said particle to nodes in said network when a label on that particle matches a label on any said edge.

2. A system as recited in claim 1:
wherein said edges comprise multiple labels.

3. A system as recited in claim 1:
wherein said particles comprise multiple labels.

4. A system as recited in claim 1:
wherein a person can add or modify labels on said labeled particles before said particles are pushed past that person's node.

5. A system as recited in claim 1:
wherein a person can add or modify labels on said labeled edges connected to that person.

6. A system as recited in claim 1:
wherein said labels comprise an identifier regarding the content of said embedded content.

7. A system as recited in claim 1:
wherein said labels comprise an identifier regarding people in said social network.

8. A system as recited in claim 1:
wherein each said label comprises a digital object.

9. A system as recited in claim 1:
wherein said propagation algorithm comprises pushing said particles only one node at a time.

10. A system as recited in claim 1:
wherein said propagation algorithm comprises pushing said particles more than one node at a time.

11. A system as recited in claim 1, further comprising:
an information space at each said node;
wherein each person is associated with a separate information space.

12. A system as recited in claim 11:
wherein each said information space at each said node comprises:
a plurality of said particles received at that node;
wherein said particles are not propagated past that node until the person associated with that information space processes said particles.

13. A system as recited in claim 1:
wherein propagation through each node is approved by the person at that node.

14. A system as recited in claim 1:
wherein multiple copies of said particles propagate through said network if a node comprises multiple edges having labels matching said labels on said particles.

15. A distribution system, comprising:
a social semantic network comprising a plurality of labeled edges;
a plurality of particles; and
a propagation algorithm;
wherein each said particle comprises at least one label; and
wherein each said particle is propagated along said edges through said network based on comparing said particle label to said labeled edges.

16. A system as recited in claim 15:
wherein said labels are digital objects.

17. A system as recited in claim 16:
wherein each said edge comprises a plurality of labels.

18. A system as recited in claim 17:
wherein multiple copies of a particle propagate through said network if multiple edges have labels matching said labels on said particles.

19. A system as recited in claim 15:
wherein said particles are generated within said social semantic network.

20. An apparatus for distributing content, comprising:
a computer; and
programming on said computer for performing the steps of:
creating edges between people in a social network;
accepting labels associated with said edges;
propagating particles along said edges in said network;
accepting labels associated with said particles; and
determining if at least one of said labels on said particles match at least one of said labels on said edges as a condition for propagation of each said particle to a next person in said social network.
